(19) United States
(12) Patent Application Publication
(10) Pub. No.: US 2026/0119032 A1
(43) Pub. Date: Apr. 30, 2026

(54) CONFIGURABLE SUBSTRATE BIASING AT A MEMORY SYSTEM

(71) Applicant: Micron Technology, Inc., Boise, ID (US)

(72) Inventor: Ken Choong Lim, Munich (DE)

(21) Appl. No.: 19/358,225

(22) Filed: Oct. 14, 2025

Related U.S. Application Data
(60) Provisional application No. 63/712,960, filed on Oct. 28, 2024.

(51) Int. Cl. G06F 3/06

(52) U.S. Cl. CPC G06F 3/0604; G06F 3/0655; G06F 3/0673

(57) ABSTRACT

Methods, systems, and devices for configurable substrate biasing at a memory system are described. The described techniques provide for a memory system to adjust a back-bias applied to a substrate of the memory system to dynamically adjust threshold access voltages associated with memory cells formed on the substrate. For example, to support high-performance operations associated with high-speed memory cells, the memory system may apply a lower voltage to the substrate, thereby lowering the threshold access voltage of the memory cells. Similarly, to mitigate charge leakage during idle durations, the memory system may apply a higher voltage to the substrate, thereby raising the threshold access voltage of the memory cells. In some cases, the memory system may apply a substrate voltage according to a speed mode, and may receive an indication to transition between speed modes from a host system.

### CROSS REFERENCE

The present Application for Patent claims priority to U.S. Patent Application No. 63/712,960 by Lim, entitled “CONFIGURABLE SUBSTRATE BIASING AT A MEMORY SYSTEM,” filed October 28, 2024, which is assigned to the assignee hereof, and which is expressly incorporated by reference in its entirety herein.

### TECHNICAL FIELD

The following relates to one or more systems for memory, including configurable substrate biasing at a memory system.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports configurable substrate biasing at a memory system in accordance with examples as disclosed herein.

FIG. 2 shows an example of a back-biasing scheme that supports configurable substrate biasing at a memory system in accordance with examples as disclosed herein.

FIG. 3 shows a block diagram of a memory system that supports configurable substrate biasing at a memory system in accordance with examples as disclosed herein.

FIG. 4 shows a flowchart illustrating a method or methods that support configurable substrate biasing at a memory system in accordance with examples as disclosed herein.

### DETAILED DESCRIPTION

Components (e.g., transistors) of a memory system may be activated by applying a voltage to a gate of the component, which may activate the component and allow current to flow between nodes of the component. In some transistor configurations (e.g., metal-oxide semiconductor field-effect transistors (MOSFETs)), the required threshold voltage to activate the transistor may be based on a voltage of a substrate the transistor is formed on. For example, the transistor may open based on a voltage differential between the gate and the substrate, such that greater threshold activation voltages may be required when the substrate is at a relatively lower voltage and vice versa. In some cases, the threshold voltage associated with a transistor may affect performance of the transistor. For example, a transistor associated with a relatively lower threshold voltage (e.g., a relatively higher substrate voltage in an N-channel MOS (NMOS) configuration or a relatively lower substrate voltage in a P-channel MOS (PMOS) configuration) may be associated with relatively quicker operational speeds, but also associated with a higher leakage current within the transistor. Alternatively, a transistor associated with a relatively higher threshold voltage (e.g., a relatively lower substrate voltage in an NMOS configuration or a relatively higher substrate voltage in a PMOS configuration) may be associated with relatively slower operational speeds, but also associated with lower charge leakage effects, such as charge leakage during idle durations. In some cases, the transistors of the memory system and the corresponding threshold voltages may be configured to be static (e.g., set during a manufacturing and testing stage). The memory system may benefit from adjusting the threshold voltage for the transistors dynamically (e.g., on the fly, during operation) to support different capabilities in different scenarios, but may be unable to make such dynamic adjustments. For example, transistors associated with peripheral circuitry (e.g., command decode circuitry, addressing circuitry, input/output (I/O) circuitry) may benefit from dynamic back-biasing.

Techniques described herein provide for a memory system to adjust a back bias of transistors on a substrate to adjust (e.g., dynamically) respective threshold voltages for transistors. For example, the threshold voltage may be proportional with the bias at the body of the transistor. To support high performance memory operations (e.g., graphics double data rate (GDDR) operations), the memory system may increase a voltage applied to a substrate coupled with wells of peripheral circuitry transistors. By increasing the voltage at the body of the transistor (e.g., a voltage applied to the well via the substrate biasing), the threshold voltage of the components may be reduced, thereby increasing operational speeds to support the higher performance memory operations. Additionally, or alternatively, to reduce charge leakage effects (e.g., charge leakage during idle times), the memory system may reduce the voltage at the body of the transistor (e.g., the voltage applied to the well via the substrate biasing), which may increase the threshold voltage of the components, thereby mitigating charge leakage.

The memory system may adjust the back bias of transistors on the substrate in response to an indication to transition speed modes. As used herein, the back bias of a transistor may refer to a voltage at a well of a transistor component (e.g., a MOSFET well), a body bias, or both. The indication may be received from a host system via a dedicated command or via a mode register command (e.g., a command to set a flag or store a value to a mode register). For example, if the host system identifies upcoming high-performance operations, the host system may indicate that the memory system is to transition to a high-speed mode (e.g., a high substrate voltage bias), and if the host system identifies an upcoming idle duration, the host system may indicate that the memory system is to transition to a low-speed mode (e.g., a low substrate voltage bias). Such techniques may enable the memory system to leverage advantages (e.g., dynamically) associated with each of high voltage back-biasing and low voltage back-biasing according to conditions at the memory system, thereby improving overall performance of the memory system.

In addition to applicability in memory systems as described herein, techniques for configurable substrate biasing may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by selectively improving memory operation speeds and reducing charge leakage, which may improve response times and mitigate latency associated with memory management operations, among other benefits.

In addition to applicability in memory systems as described herein, techniques for configurable substrate biasing may be generally implemented to support edge computing applications. Edge computing is a distributed computing paradigm that brings computation and data storage closer to the sources of data than traditional cloud services. As the use of edge computing to provide computing, storage, and networking services at locations that are geographically closer to end users increases, many devices and systems may benefit from improved processing, performance, and storage at edge devices. For example, increasing memory density, capacity, and processing power of edge devices may decrease a reliance on the devices to remote computing or devices, which may otherwise increase latency of operations performed at the devices. Implementing the techniques described herein may support edge computing techniques by improving memory operation speeds and power performance at edge computing devices and reducing latency associated with memory management operations, among other benefits.

Features of the disclosure are illustrated and described in the context of a system. Features of the disclosure are further illustrated and described in the context of a back-biasing scheme and flowcharts.

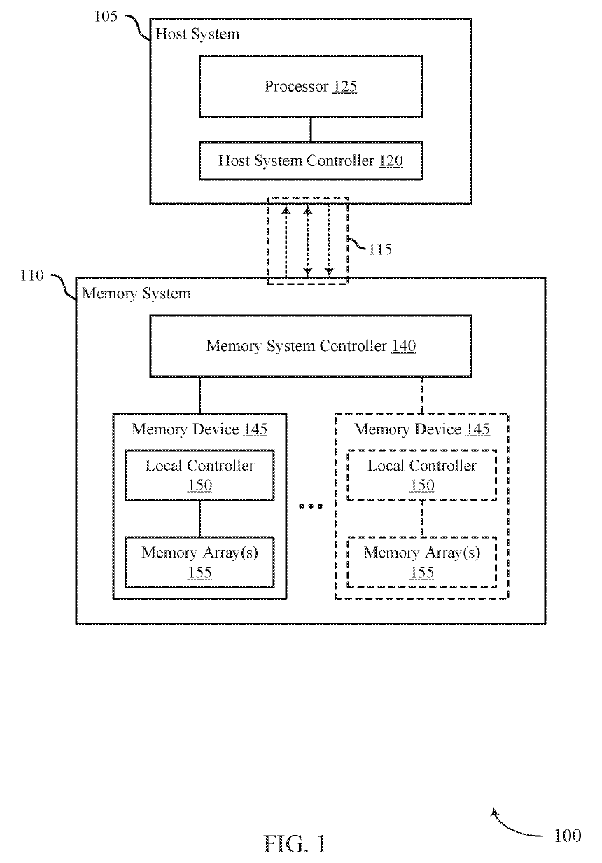

FIG. 1 illustrates an example of a system 100 that supports configurable substrate biasing at a memory system in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

The host system 105 may include one or more components (e.g., circuitry, processing circuitry, one or more processing components) that use memory to execute processes, any one or more of which may be referred to as or be included in a processor 125. The processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. The processor 125 may be an example of a central processing unit (CPU), a graphics processing unit (GPU), a general-purpose GPU (GPGPU), or an SoC or a component thereof, among other examples.

The host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating the memory system 110, such as write commands, read commands, configuration signaling or other operational signaling. In some examples, the host system controller 120, or associated functions described herein, may be implemented by or be part of the processor 125. For example, a host system controller 120 may be hardware, instructions (e.g., software, firmware), or some combination thereof implemented by the processor 125 or other component of the host system 105. In various examples, a host system 105 or a host system controller 120 may be referred to as a host.

The memory system 110 provides physical memory locations (e.g., addresses) that may be used or referenced by the system 100. The memory system 110 may include a memory system controller 140 and one or more memory devices 145 (e.g., memory packages, memory dies, memory chips) operable to store data. The memory system 110 may be configurable for operations with different types of host systems 105, and may respond to commands from the host system 105 (e.g., from a host system controller 120). For example, the memory system 110 (e.g., a memory system controller 140) may receive a write command indicating that the memory system 110 is to store data received from the host system 105, or receive a read command indicating that the memory system 110 is to provide data stored in a memory device 145 to the host system 105, or receive a refresh command indicating that the memory system 110 is to refresh data stored in a memory device 145, among other types of commands and operations.

A memory system controller 140 may include at least one of one or more components (e.g., circuitry, logic, instructions) operable to control operations of the memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with the host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include a local controller 150 and one or more memory arrays 155. A memory array 155 may be a collection of memory cells (e.g., a two-dimensional array, a three-dimensional array), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not-or (NOR) memory cells, and not-and (NAND) memory cells, or any combination thereof.

A local controller 150 may include at least one of one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 may be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

Signaling may be communicated over the channels 115 using single data rate (SDR) signaling or double data rate (DDR) signaling, among other rates (e.g., relative to a clock signal). In SDR signaling, one modulation symbol (e.g., signal level) of a signal may be registered for each clock cycle (e.g., on a rising edge or a falling edge of a clock signal). In DDR signaling, two modulation symbols of a signal may be registered for each clock cycle (e.g., on both a rising edge and a falling edge of a clock signal).

In some memory systems 110, components (e.g., transistors) of the memory system 110 may be activated by applying a voltage to a gate of the component, which may open (e.g., activate) the component and allow current to flow between nodes of the component. For example, a MOSFET may be activated based on receiving a required threshold voltage to activate the MOSFET, where the threshold voltage may be based on a voltage of a substrate the transistor is formed on. The transistor may open based on a voltage differential between the gate and the substrate, such that greater threshold voltages may be required when the substrate is at a relatively lower voltage and vice versa. In some cases, the threshold voltage associated with a transistor may affect performance of the transistor. For example, a transistor associated with a relatively lower threshold voltage (e.g., a relatively higher substrate voltage in an NMOS configuration or a relatively lower substrate voltage in a PMOS configuration) may be associated with relatively quicker operational speeds. Alternatively, a transistor associated with a relatively higher threshold voltage (e.g., a relatively lower substrate voltage in an NMOS configuration or a relatively higher substrate voltage in a PMOS configuration) may be associated with relatively lower charge leakage effects, such as charge leakage during idle durations. In some cases, the transistors of the memory system 110 and the corresponding threshold voltages may be configured to be static (e.g., set during a manufacturing and testing stage). The memory system 110 may benefit from adjusting the threshold voltage for a transistor dynamically (e.g., on the fly, during operation) to support different capabilities in different scenarios, but may be unable to make such dynamic adjustments. For example, transistors associated with peripheral circuitry (e.g., command decode circuitry, addressing circuitry, input/output (I/O) circuitry) may benefit from dynamic back-biasing.

Techniques described herein provide for a memory system 110 to adjust a back bias of transistors on a substrate to adjust (e.g., dynamically) respective threshold voltages for MOSFETs. For example, to support high performance memory operations (e.g., GDDR operations), the memory system 110 may increase a voltage applied to a substrate coupled with well of peripheral circuitry transistors. By increasing the voltage at the body of the transistor (e.g., a voltage applied to the well via the substrate biasing), the threshold voltage of the components may be reduced, thereby increasing operational speeds to support the higher performance memory operations. Additionally, or alternatively, to reduce charge leakage effects (e.g., charge leakage during idle times), the memory system 110 may reduce the voltage at the body of the transistor (e.g., the voltage applied to the well via the substrate biasing), which may increase the threshold voltage of the memory cells, thereby mitigating charge leakage.

The memory system 110 may adjust the back bias of transistors on the substrate in response to an indication to transition speed modes. As used herein, the back bias of a transistor may refer to a voltage at a well of a transistor component (e.g., a MOSFET well), a body bias, or both. The indication may be received from a host system 105 via a dedicated command or via a mode register command (e.g., a command to set a flag or store a value to a mode register). For example, if the host system 105 identifies upcoming high-performance operations, the host system may indicate that the memory system 110 is to transition to a high-speed mode (e.g., a high substrate voltage bias), and if the host system 105 identifies an upcoming idle duration, the host system 105 may indicate that the memory system 110 is to transition to a low-speed mode (e.g., a low substrate voltage bias). Such techniques may enable the memory system 110 to leverage advantages (e.g., dynamically) associated with each of high voltage back-biasing and low voltage back-biasing according to conditions at the memory system 110, thereby improving overall performance of the memory system 110.

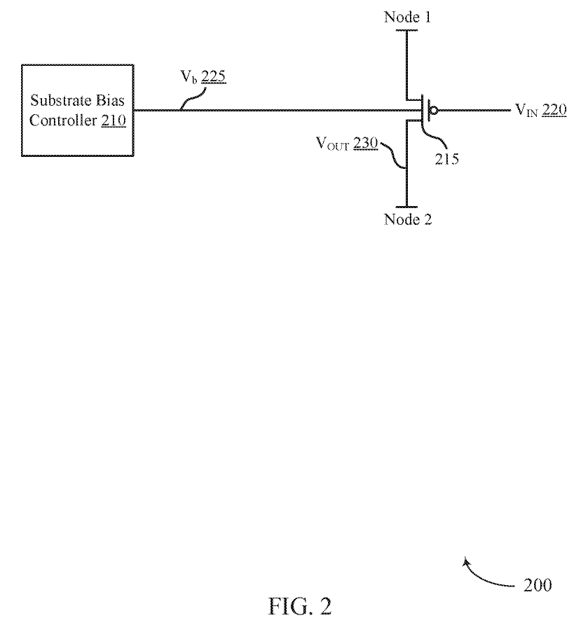

FIG. 2 illustrates an example of a back-biasing scheme 200 that supports configurable substrate biasing at a memory system in accordance with examples as disclosed herein. The back-biasing scheme 200 may implement, or be implemented by, one or more aspects of the system 100. For example, the back-biasing scheme 200 illustrates circuitry associated with a component 215, which may be an example of a transistor associated with peripheral circuitry included in a memory device 145 described with reference to FIG. 1. Additionally, the back-biasing scheme 200 includes a substrate bias controller 210, which may be an example of or included as part of a memory system controller 140 or a local controller 150 described with reference to FIG. 1. In some cases, the back-biasing scheme 200 may support a memory system adjusting, by the substrate bias controller 210, a voltage of a substrate associated with the component 215 (e.g., a well of the component 215, a voltage between a source and a body of the component 215) to adjust a threshold voltage of the component 215.

In some examples, the component 215 may be a MOSFET, where the component 215 may be activated in response to a threshold voltage differential between a gate and a well of the component 215. For example, the component 215 may be activated when a voltage difference between an input voltage, V_{IN}220, and a substrate bias (e.g., a body bias, a back-bias), V_{b}225, is equal to or greater than a threshold voltage. If the component 215 is activated, a channel of the component 215 may open, connecting a source and drain of the component 215, which may support the operation of periphery circuitry. For example, activating the component 215 may support the memory system transferring data to a host system, such as when the component 215 is associated with I/O circuitry, among other examples.

It should be noted that the techniques described herein may be applicable to any type of transistor structure, including at least a pull-up transistor structure, a pull-down transistor structure, or a complementary metal-oxide-semiconductor (CMOS) structure (e.g., including both pull-up and pull-down MOSFETs). Further, the component 215 may be an example of or otherwise include a p-channel metal oxide semiconductor (PMOS) transistor, an n-channel metal oxide semiconductor (NMOS) transistor, or both.

As described herein, a back-bias may refer to a voltage applied to a well of the component 215, a body bias of the component 215, or both. In some examples, the substrate bias controller 210 may support back-biasing, and may be configured to apply one or more voltages to a substrate (e.g., associated with a source to body voltage of the component 215) via one or more electrical connections. Such back-biasing may result in a change in an input voltage that is required to activate (e.g., open) a MOSFET, or a threshold voltage of the MOSFET, which may enable dynamic threshold voltage adjustment according to desired operations of the memory system.

Due to the activation of the component 215 being related to a voltage differential, the magnitude of V_{IN}220 to open the component 215 may be based on the magnitude of V_{b}225. This magnitude of V_{IN}220 relative to the magnitude of V_{b}225 may be referred to as a threshold voltage or V_{T} (e.g., a voltage differential sufficient to open or activate the component 215). For example, in a PMOS configuration, if V_{b}225 is a relatively low voltage, then the V_{T} may be relatively high when activating the component 215. Similarly, in the PMOS configuration, if V_{b}225 is a relatively high voltage, then the V_{T} may be relatively low when activating the component 215. Alternatively, in an NMOS configuration, if V_{b}225 is a relatively low voltage, then the V_{T} (e.g., the magnitude of V_{IN}225 that results in activating the component 215) may be relatively low when activating the component 215. Similarly, in the NMOS configuration, if V_{b}225 is a relatively high voltage, then the V_{T} may be relatively high when activating the component 215. It should be noted that while the component 215 is illustrated and described with reference to a PMOS transistor structure, the techniques described herein may be applicable to a NMOS transistor structure by biasing V_{b}225 to achieve appropriate V_{T} values.

In some cases, the V_{T} of the component 215 may affect one or more performance metrics of the memory system. For example, a relatively lower V_{T} may increase the speed associated with activating the component 215 (e.g., due to applying relatively less voltage, or a relatively lower voltage at V_{IN}220 when executing an operation), thereby improving performance while the memory system operates. As another example, a relatively higher V_{T} may mitigate charge leakage effects associated with the component 215 (e.g., a larger well voltage may reduce the likelihood of leakage at the component 215), thereby improving power performance of the memory system.

The memory system may leverage advantageous effects associated with both high V_{T} and low V_{T} activation of the component 215 by adjusting a bias of the substrate (e.g., adjusting V_{b}225) according to one or more speed modes of the memory system. For example, the substrate bias controller 210 may be configured to adjust the voltage V_{b} 225 applied to the well of one or more components 215 (e.g., applying a back-bias). The substrate bias controller 210 may include any quantity of connections to any quantity of components 215 and types of components 215, and is not limited to the example illustrated by FIG. 2. For example, the substrate bias controller 210 may include one or more positive bias lines (e.g., V_{bp}), one or more negative bias lines (e.g., V_{bn}), or both connected to one or more p-type, n-type, or CMOS components 215.

In some cases, a first speed mode of the memory system may support higher operational speeds (e.g., a high speed mode), and may be associated with a relatively low V_{T} for the component 215. For example, while operating in the first speed mode, the substrate bias controller 210 may apply a relatively low voltage to the substrate (V_{b}225) coupled with the well of the component 215. Additionally, or alternatively, a second speed mode of the memory system may support reduced charge leakage, and may be associated with a relatively high V_{T} for the component 215. For example, while operating in the second speed mode, the substrate bias controller 210 may apply a relatively high voltage to the substrate (V_{b}225) coupled with the well of the component 215. The substrate bias controller 210 may apply the voltage V_{b}225 according to a range of voltages, including at least a high-speed (e.g., fast) voltage and a low-speed (e.g., slow) voltage. In some cases, a single range of voltages may be configured for each type of memory cell 205, including PMOS, NMOS, or CMOS transistors (e.g., V_{bp} and V_{bn} lines are configured to carry the same range of voltages for transitioning speed modes). Alternatively, respective ranges of voltages may be configured for respective types of components 215. For example, V_{bp} lines may be configured to carry a first range of voltages and V_{bn} lines may be configured to carry a second range of voltages different from the first range (e.g., offset in magnitude).

In some examples, the range of values (e.g., the low-speed back-bias and the high-speed back-bias) may be configured according to one or more process, voltage, and temperature (PVT) characteristics of the memory system. For example, the voltages available to apply to a substrate may depend on whether a temperature of the memory system satisfies a threshold temperature. Additionally, or alternatively, the voltages available to apply to a substrate may depend on process variations caused by changes in manufacturing of the memory system (e.g., deviations in the semiconductor fabrication process). For example, a manufacturer of the memory system may optimize the range of voltages during a product testing phase (e.g., at the manufacturer), and may store the range of voltages to the memory system (e.g., in a fuse array or as part of trim data) to improve performance and reliability of the memory system. In some examples, the voltages may be based on nominal voltage ranges associated with operating the memory system.

Additionally, or alternatively, different sets of components 215 in the memory system may be associated with different ranges of V_{b} 225. As an example, a portion of components 215 may be associated with relatively higher-speed operations (e.g., components 215 supporting I/O line operations), and may have relatively lower V_{b}225 values at each speed mode. In this example, a high-performance component 215 may receive a first value of V_{b}225 when operating in the high-speed mode and may receive a second value of V_{b} 225 when operating in the low-speed mode, and a low-performance component 215 may receive a third value of V_{b}225 when operating in the high-speed mode and may receive a fourth value of V_{b} 225 when operating in the low-speed mode, where the first value is lower than the third value and the second value is lower than the fourth value.

In some examples, the memory system may switch between the first and second speed mode in response to an indication to transition between the speed modes. For example, a host system (e.g., the host system 105 described with reference to FIG. 1) may determine a speed mode for the memory system to operate in and may send the indication to transition speed modes to the memory system. In some cases, the host system may indicate to transition to the first speed mode to support upcoming high-performance operations at the memory system. Alternatively, the host system may indicate to transition to the second speed mode to mitigate charge leakage during an upcoming idle duration. For example, the host system may identify that the memory system will not be operated for an upcoming duration, such as the memory system entering a low-power or off state, the host system executing tasks unrelated to the memory system, or the memory system completing a manufacturing stage and remaining idle until first operation (e.g., an ‘on the shelf’ duration), among other examples. Alternatively, the host system may identify that upcoming tasks for the memory system are not related to high-performance or high-speed operations, where lowering operational speed and mitigating charge leakage is desirable. In such examples, the host system may transmit the indication to transition to the second speed mode to reduce charge leakage effects and improve power performance of the memory system.

In some examples, the host system may transmit a command to the memory system including the indication to transition speed modes. Alternatively, the memory system may identify the indication by reading a value of a mode register. For example, during a frequency change sequence (e.g., to adjust an operating frequency of the memory system), the host system may issue one or more mode register values to indicate one or more parameters associated with the frequency change sequence, and may issue an additional mode register value to indicate to adjust the substrate bias and transition speed modes.

Such techniques may improve performance of the memory system by enabling configurable back-biasing and leveraging advantageous effects associated with high V_{T} and low V_{T} memory cells. For example, operational speeds and power performance of the memory system may be improved.

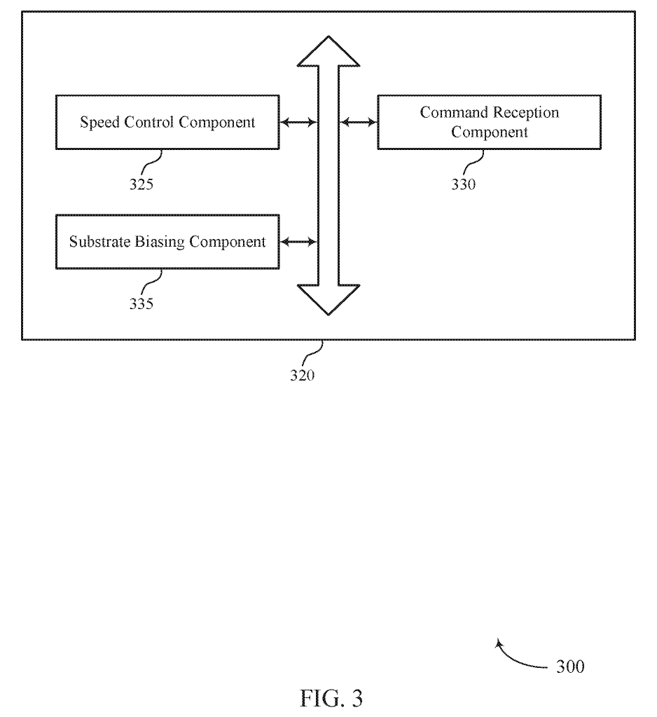

FIG. 3 shows a block diagram 300 of a memory system 320 that supports configurable substrate biasing at a memory system in accordance with examples as disclosed herein. The memory system 320 may be an example of aspects of a memory system as described with reference to FIGS. 1 and 2. The memory system 320, or various components thereof, may be an example of means for performing various aspects of configurable substrate biasing at a memory system as described herein. For example, the memory system 320 may include a speed control component 325, a command reception component 330, a substrate biasing component 335, or any combination thereof. Each of these components, or components of subcomponents thereof (e.g., one or more processors, one or more memories), may communicate, directly or indirectly, with one another (e.g., via one or more buses).

The speed control component 325 may be configured as or otherwise support a means for operating a memory device of the memory system according to a first speed mode, where a threshold voltage of a component of the memory system is based at least in part on a first back-bias voltage applied to the component as part of operating the memory device in the first speed mode. The command reception component 330 may be configured as or otherwise support a means for receiving an indication to transition from the first speed mode to a second speed mode. The substrate biasing component 335 may be configured as or otherwise support a means for modifying the first back-bias voltage to a second back-bias voltage based at least in part on receiving the indication. In some examples, the speed control component 325 may be configured as or otherwise support a means for operating the memory device according to the second speed mode based at least in part on the second back-bias voltage, where the threshold voltage of the component is different in response to the second back-bias voltage as compared to the first back-bias voltage.

In some examples, the substrate biasing component 335 may be configured as or otherwise support a means for biasing, in response to operating according to the first speed mode, a substrate of the memory system to the first back-bias voltage, where the threshold voltage of the component of the memory system is based at least in part on the first back-bias voltage of the substrate. In some examples, the substrate biasing component 335 may be configured as or otherwise support a means for biasing, in response to the indication to transition from the first speed mode to the second speed mode, the substrate to the second back-bias voltage, where the threshold voltage of the component is different based at least in part on the second back-bias voltage of the substrate.

In some examples, the first back-bias voltage and the second back-bias voltage are based at least in part on one or more process, voltage, and temperature (PVT) characteristics of the memory system.

In some examples, a threshold voltage of a second component of the memory system is based at least in part on a third back-bias voltage applied to the component as part of operating the memory device in the first speed mode, and the substrate biasing component 335 may be configured as or otherwise support a means for modifying the third back-bias voltage to a fourth back-bias voltage based at least in part on receiving the indication, where the threshold voltage of the second component is different in response to the fourth back-bias voltage.

In some examples, the threshold voltage of the component of the memory system is less when operating the memory device in the first speed mode than when operating the memory device in the second speed mode. In some examples, the second speed mode is associated with a greater memory access speed than the first speed mode based at least in part on the threshold voltage of the component of the memory system being less when operating the memory device in the first speed mode than when operating the memory device in the second speed mode.

In some examples, to support receiving the indication to transition from the first speed mode to the second speed mode, the command reception component 330 may be configured as or otherwise support a means for receiving, from a host device, a command including the indication.

In some examples, the command reception component 330 may be configured as or otherwise support a means for reading a value of a mode register of the memory system, where receiving the indication is based at least in part on the value read from the mode register.

In some examples, while operating according to the first speed mode, a threshold voltage of a third component of the memory system is different than the threshold voltage of the component of the memory system.

In some examples, the component of the memory system includes a transistor.

In some examples, the described functionality of the memory system 320, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 320, or various components thereof, may be implemented at least in part by instructions (e.g., stored in memory, non-transitory computer-readable medium) executable by such at least one processor.

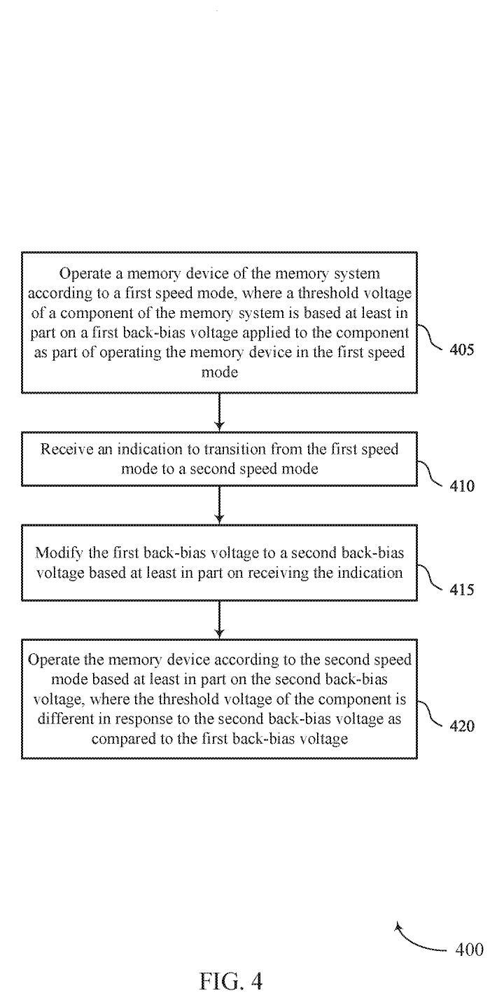

FIG. 4 shows a flowchart illustrating a method 400 that supports configurable substrate biasing at a memory system in accordance with examples as disclosed herein. The operations of method 400 may be implemented by a memory system or its components as described herein. For example, the operations of method 400 may be performed by a memory system as described with reference to FIGS. 1 through 3. In some examples, a memory system may execute a set of instructions to control the functional elements of the device to perform the described functions. Additionally, or alternatively, the memory system may perform aspects of the described functions using special-purpose hardware.

At 405, the method may include operating a memory device of the memory system according to a first speed mode, where a threshold voltage of a component of the memory system is based at least in part on a first back-bias voltage applied to the component as part of operating the memory device in the first speed mode. In some examples, aspects of the operations of 405 may be performed by a speed control component 325 as described with reference to FIG. 3.

At 410, the method may include receiving an indication to transition from the first speed mode to a second speed mode. In some examples, aspects of the operations of 410 may be performed by a command reception component 330 as described with reference to FIG. 3.

At 415, the method may include modifying the first back-bias voltage to a second back-bias voltage based at least in part on receiving the indication. In some examples, aspects of the operations of 415 may be performed by a substrate biasing component 335 as described with reference to FIG. 3.

At 420, the method may include operating the memory device according to the second speed mode based at least in part on the second back-bias voltage, where the threshold voltage of the component is different in response to the second back-bias voltage as compared to the first back-bias voltage. In some examples, aspects of the operations of 420 may be performed by a speed control component 325 as described with reference to FIG. 3.

In some examples, an apparatus as described herein may perform a method or methods, such as the method 400. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for operating a memory device of the memory system according to a first speed mode, where a threshold voltage of a component of the memory system is based at least in part on a first back-bias voltage applied to the component as part of operating the memory device in the first speed mode; receiving an indication to transition from the first speed mode to a second speed mode; modifying the first back-bias voltage to a second back-bias voltage based at least in part on receiving the indication; and operating the memory device according to the second speed mode based at least in part on the second back-bias voltage, where the threshold voltage of the component is different in response to the second back-bias voltage as compared to the first back-bias voltage.

Aspect 2: The method, apparatus, or non-transitory computer-readable medium of aspect 1, further including operations, features, circuitry, logic, means, or instructions, or any combination thereof for biasing, in response to operating according to the first speed mode, a substrate of the memory system to the first back-bias voltage, where the threshold voltage of the component of the memory system is based at least in part on the first back-bias voltage of the substrate and biasing, in response to the indication to transition from the first speed mode to the second speed mode, the substrate to the second back-bias voltage, where the threshold voltage of the component is different based at least in part on the second back-bias voltage of the substrate.

Aspect 3: The method, apparatus, or non-transitory computer-readable medium of aspect 2, where the first back-bias voltage and the second back-bias voltage are based at least in part on one or more process, voltage, and temperature (PVT) characteristics of the memory system.

Aspect 4: The method, apparatus, or non-transitory computer-readable medium of any of aspects 1 through 3, where a threshold voltage of a second component of the memory system is based at least in part on a third back-bias voltage applied to the component as part of operating the memory device in the first speed mode and the method, apparatuses, and non-transitory computer-readable medium further includes operations, features, circuitry, logic, means, or instructions, or any combination thereof for modifying the third back-bias voltage to a fourth back-bias voltage based at least in part on receiving the indication, where the threshold voltage of the second component is different in response to the fourth back-bias voltage.

Aspect 5: The method, apparatus, or non-transitory computer-readable medium of any of aspects 1 through 4, where the threshold voltage of the component of the memory system is less when operating the memory device in the first speed mode than when operating the memory device in the second speed mode and the second speed mode is associated with a greater memory access speed than the first speed mode based at least in part on the threshold voltage of the component of the memory system being less when operating the memory device in the first speed mode than when operating the memory device in the second speed mode.

Aspect 6: The method, apparatus, or non-transitory computer-readable medium of any of aspects 1 through 5, where receiving the indication to transition from the first speed mode to the second speed mode includes operations, features, circuitry, logic, means, or instructions, or any combination thereof for receiving, from a host device, a command including the indication.

Aspect 7: The method, apparatus, or non-transitory computer-readable medium of any of aspects 1 through 6, further including operations, features, circuitry, logic, means, or instructions, or any combination thereof for reading a value of a mode register of the memory system, where receiving the indication is based at least in part on the value read from the mode register.

Aspect 8: The method, apparatus, or non-transitory computer-readable medium of any of aspects 1 through 7, where while operating according to the first speed mode, a threshold voltage of a third component of the memory system is different than the threshold voltage of the component of the memory system.

Aspect 9: The method, apparatus, or non-transitory computer-readable medium of any of aspects 1 through 8, where the component of the memory system includes a transistor.

It should be noted that the aspects described herein describe possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (e.g., in conductive contact with, connected with, coupled with) one another if there is any electrical path (e.g., conductive path) between the components that can, at any time, support the flow of signals (e.g., charge, current, voltage) between the components. A conductive path between components that are in electronic communication with each other (e.g., in conductive contact with, connected with, coupled with) may be an open circuit or a closed circuit based on the operation of the device that includes the connected components. A conductive path between connected components may be a direct conductive path between the components or may be an indirect conductive path that includes intermediate components, such as switches, transistors, or other components. In some examples, the flow of signals between the connected components may be interrupted for a time, for example, using one or more intermediate components such as switches or transistors.

The term “isolated” may refer to a relationship between components in which signals are not presently capable of flowing between the components. Components are isolated from each other if there is an open circuit between them. For example, two components separated by a switch that is positioned between the components are isolated from each other when the switch is open. When a component isolates two components, the component may initiate a change that prevents signals from flowing between the other components using a conductive path that previously permitted signals to flow.

The term “coupling” (e.g., “electrically coupling”) may refer to condition of moving from an open-circuit relationship between components in which signals are not presently capable of being communicated between the components (e.g., over a conductive path) to a closed-circuit relationship between components in which signals are capable of being communicated between components (e.g., over the conductive path). When a component, such as a controller, couples other components together, the component may initiate a change that allows signals to flow between the other components over a conductive path that previously did not permit signals to flow.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOS), or epitaxial layers of semiconductor materials on another substrate. The conductivity of the substrate, or sub-regions of the substrate, may be controlled through doping using various chemical species including, but not limited to, phosphorous, boron, or arsenic.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method by a memory system, comprising:
operating a memory device of the memory system according to a first speed mode, wherein a threshold voltage of a component of the memory system is based at least in part on a first back-bias voltage applied to the component as part of operating the memory device in the first speed mode;
receiving an indication to transition from the first speed mode to a second speed mode;
modifying the first back-bias voltage to a second back-bias voltage based at least in part on receiving the indication; and
operating the memory device according to the second speed mode based at least in part on the second back-bias voltage, wherein the threshold voltage of the component is different in response to the second back-bias voltage as compared to the first back-bias voltage.

2. The method of claim 1, further comprising:
biasing, in response to operating according to the first speed mode, a substrate of the memory system to the first back-bias voltage, wherein the threshold voltage of the component of the memory system is based at least in part on the first back-bias voltage of the substrate; and
biasing, in response to the indication to transition from the first speed mode to the second speed mode, the substrate to the second back-bias voltage, wherein the threshold voltage of the component is different based at least in part on the second back-bias voltage of the substrate.

3. The method of claim 2, wherein the first back-bias voltage and the second back-bias voltage are based at least in part on one or more process, voltage, and temperature (PVT) characteristics of the memory system.

4. The method of claim 1, wherein a threshold voltage of a second component of the memory system is based at least in part on a third back-bias voltage applied to the component as part of operating the memory device in the first speed mode, the method further comprising:
modifying the third back-bias voltage to a fourth back-bias voltage based at least in part on receiving the indication, wherein the threshold voltage of the second component is different in response to the fourth back-bias voltage.

5. The method of claim 1, wherein the threshold voltage of the component of the memory system is less when operating the memory device in the first speed mode than when operating the memory device in the second speed mode, and wherein the second speed mode is associated with a greater memory access speed than the first speed mode based at least in part on the threshold voltage of the component of the memory system being less when operating the memory device in the first speed mode than when operating the memory device in the second speed mode.

6. The method of claim 1, wherein receiving the indication to transition from the first speed mode to the second speed mode comprises:
receiving, from a host device, a command comprising the indication.

7. The method of claim 1, further comprising:
reading a value of a mode register of the memory system, wherein receiving the indication is based at least in part on the value read from the mode register.

8. The method of claim 1, wherein while operating according to the first speed mode, a threshold voltage of a third component of the memory system is different than the threshold voltage of the component of the memory system.

9. The method of claim 1, wherein the component of the memory system comprises a transistor.

10. A memory system, comprising:
one or more memory devices; and
processing circuitry coupled with the one or more memory devices and configured to cause the memory system to:
operate a memory device of the one or more memory devices according to a first speed mode, wherein a threshold voltage of a component of the memory system is based at least in part on a first back-bias voltage applied to the component as part of operating the memory device in the first speed mode;
receive an indication to transition from the first speed mode to a second speed mode;
modify the first back-bias voltage to a second back-bias voltage based at least in part on receiving the indication; and
operate the memory device according to the second speed mode based at least in part on the second back-bias voltage, wherein the threshold voltage of the component is different in response to the second back-bias voltage as compared to the first back-bias voltage.

11. The memory system of claim 10, wherein the processing circuitry is further configured to cause the memory system to:
bias, in response to operate according to the first speed mode, a substrate of the memory system to the first back-bias voltage, wherein the threshold voltage of the component of the memory system is based at least in part on the first back-bias voltage of the substrate; and
bias, in response to the indication to transition from the first speed mode to the second speed mode, the substrate to the second back-bias voltage, wherein the threshold voltage of the component be different based at least in part on the second back-bias voltage of the substrate.

12. The memory system of claim 11, wherein the first back-bias voltage and the second back-bias voltage are based at least in part on one or more process, voltage, and temperature (PVT) characteristics of the memory system.

13. The memory system of claim 10, wherein a threshold voltage of a second component of the memory system is based at least in part on a third back-bias voltage applied to the component as part of operating the memory device in the first speed mode, and the processing circuitry is further configured to cause the memory system to:
modify the third back-bias voltage to a fourth back-bias voltage based at least in part on receiving the indication, wherein the threshold voltage of the second component is different in response to the fourth back-bias voltage.

14. The memory system of claim 10, wherein the threshold voltage of the component of the memory system is less when operating the memory device in the first speed mode than when operating the memory device in the second speed mode, and wherein the second speed mode is associated with a greater memory access speed than the first speed mode based at least in part on the threshold voltage of the component of the memory system being less when operating the memory device in the first speed mode than when operating the memory device in the second speed mode.

15. The memory system of claim 10, wherein receiving the indication to transition from the first speed mode to the second speed mode comprises the processing circuitry configured to cause the memory system to:
receive, from a host device, a command comprising the indication.

16. The memory system of claim 10, wherein the processing circuitry is further configured to cause the memory system to:
read a value of a mode register of the memory system, wherein receiving the indication is based at least in part on the value read from the mode register.

17. The memory system of claim 10, wherein while operating according to the first speed mode, a threshold voltage of a third component of the memory system is different than the threshold voltage of the component of the memory system.

18. The memory system of claim 10, wherein the component of the memory system comprises a transistor.

19. A non-transitory computer-readable medium storing code, the code comprising instructions executable by one or more processors to:
operate a memory device of the memory system according to a first speed mode, wherein a threshold voltage of a component of the memory system is based at least in part on a first back-bias voltage applied to the component as part of operating the memory device in the first speed mode;
receive an indication to transition from the first speed mode to a second speed mode;
modify the first back-bias voltage to a second back-bias voltage based at least in part on receiving the indication; and
operate the memory device according to the second speed mode based at least in part on the second back-bias voltage, wherein the threshold voltage of the component is different in response to the second back-bias voltage as compared to the first back-bias voltage.

20. The non-transitory computer-readable medium of claim 19, wherein the instructions are further executable by the one or more processors to:
bias, in response to operate according to the first speed mode, a substrate of the memory system to the first back-bias voltage, wherein the threshold voltage of the component of the memory system is based at least in part on the first back-bias voltage of the substrate; and
bias, in response to the indication to transition from the first speed mode to the second speed mode, the substrate to the second back-bias voltage, wherein the threshold voltage of the component be different based at least in part on the second back-bias voltage of the substrate.
